(19) United States
(12) Patent Application Publication
(10) Pub. No.: US 2006/0147211 A1
(43) Pub. Date: Jul. 6, 2006

(54) Wavelength-division-multiplexed passive optical network

(75) Inventors: Sang-Ho Kim, Seoul (KR); Chang-Sup Shim, Seoul (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/197,175

(22) Filed: Aug. 4, 2005

(30) Foreign Application Priority Data
Dec. 30, 2004 (KR) 2004-116406

(51) Int. Cl. H04J 14/00

(52) U.S. Cl. 398/72

(57) ABSTRACT

A wavelength division multiplexing passive optical network including optical lines for link is disclosed. The passive optical network includes a plurality of optical network units each of which generates an upstream optical signal; a central office for generating downstream optical signals to be provided to each of the optical network units, and differentially converting each of the upstream optical signals into a monitoring signal and a received signal. Changes in the wavelength of each of the upstream optical signals are monitored and if there is an abnormality in each optical line by using relevant monitoring signals. The network also includes a remote node for multiplexing and outputting the upstream optical signals to the central office, and demultiplexing and outputting the downstream optical signals to corresponding optical network units.

### CLAIM OF PRIORITY

This application claims to the benefit under 35 U.S.C. 119(a) of an application entitled “Wavelength-Division-Multiplexed Passive Optical Network,” filed in the Korean Intellectual Property Office on Dec. 30, 2004 and assigned Serial No. 2004-116406, the entire contents of which are incorporated herein by reference.

### BACKGROUND OF THE INVENTION

1. Field of the Invention

The present invention relates to a wavelength-division-multiplexed passive optical network, and more particularly to a wavelength-division-multiplexed passive optical network including a means for monitoring optical lines and changes in wavelength.

2. Description of the Related Art

In a conventional wavelength-division-multiplexed optical communication scheme, a specific wavelength is allocated to each optical network unit. In this way, particular data can be carried by light having a relevant wavelength. In such a wavelength-division-multiplexed optical communication scheme, the data is secure because a distinct wavelength is allocated to each optical network unit. In such scheme, it is also relatively easy to expand the network when the number of subscribers increases.

Conventional passive optical networks include a central office for providing service, a plurality of optical network units for receiving the service, and a remote node located between the central office and the optical network units. The remote node performs a relaying function between the central office and the optical network units. The central office and the remote node are linked by a single optical line.

In such passive optical networks, the optical network units are located near the remote node, and each optical network unit is linked to the remote node by a distinct optical line. This forms a double-star structure. Accordingly, the passive optical network has an advantage in that it is simple to bury and manage optical lines.

The central office provides multiplexed downstream optical signals to each optical network unit and outputs the multiplexed downstream optical signals to the remote node. The remote node demultiplexes and outputs the multiplexed downstream optical signals to each corresponding optical network unit.

Each of the optical network units detects a relevant downstream optical signal and generates an upstream optical signal having a predetermined wavelength. The remote node multiplexes the upstream optical signals input from the optical network units and outputs the multiplexed upstream optical signals to the central office. The central office demultiplexes the multiplexed upstream optical signals to detect each upstream optical signal.

Such passive optical networks, however, are sensitive to wavelength changes due to temperature changes. Such wavelength changes may cause a malfunction in a relevant optical network unit or in the central office.

Korean Patent Application No. 10-2002-0060868, invented by Chu Kwang-Uk, et al. and entitled “Bi-Directional Wavelength Division Multiplexing Passive Optical Network Using Light Source Wavelength-Locked By Injected Incoherent Light” discloses a means for monitoring and controlling a malfunction caused by temperature change.

However, change of the intensity of entire multiplexed upstream optical signals is used for monitoring wavelength changes of entire upstream optical signals and to perform a corresponding control operation. Accordingly, it is impossible to individually monitor and control each of demultiplexed upstream optical signals. When an optical network unit stops generating an upstream optical signal, the central office senses it just as change in the entire intensity of the upstream optical signals and mis-regards it as a wavelength change.

### SUMMARY OF THE INVENTION

One aspect of the present invention relates to a wavelength division multiplexing passive optical network which can monitor wavelength change of each demultiplexed optical signal and perform a corresponding control operation.

One embodiment of the present invention is directed to a wavelength division multiplexing passive optical network including optical lines for link. The passive optical network includes a plurality of optical network units each of which generate an upstream optical signal, a central office for generating downstream optical signals to be provided to each of the optical network units, and differentially converting each of the upstream optical signals into a monitoring signal and a received signal. This allows for monitoring of change in the wavelength of each of the upstream optical signals and if there is an abnormality in each optical line by using relevant monitoring signals and the network also includes a remote node for multiplexing and outputting the upstream optical signals to the central office, and demultiplexing and outputting the downstream optical signals to corresponding optical network units.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a block diagram illustrating a configuration of a wavelength division multiplexing passive optical network according to a first embodiment of the present invention;

FIG. 2 is a block diagram illustrating a configuration of a wavelength division multiplexing passive optical network according to a second embodiment of the present invention;

FIG. 3 is a block diagram illustrating a configuration of a wavelength division multiplexing passive optical network according to a third embodiment of the present invention;

FIG. 4 is a block diagram illustrating a configuration of the monitoring unit shown in FIG. 2;

FIG. 5 is a graph for explaining the operation of the monitoring unit shown in FIG. 2; and

FIG. 6 is a flowchart for explaining a method of monitoring wavelength change of each demultiplexed optical signal according to an embodiment of the present invention.

### DETAILED DESCRIPTION

Hereinafter, embodiments according to the present invention will be described with reference to the accompanying drawings. For the purposes of clarity and simplicity, a detailed description of known functions and configurations incorporated herein will be omitted as it may obscure the subject matter of the present invention.

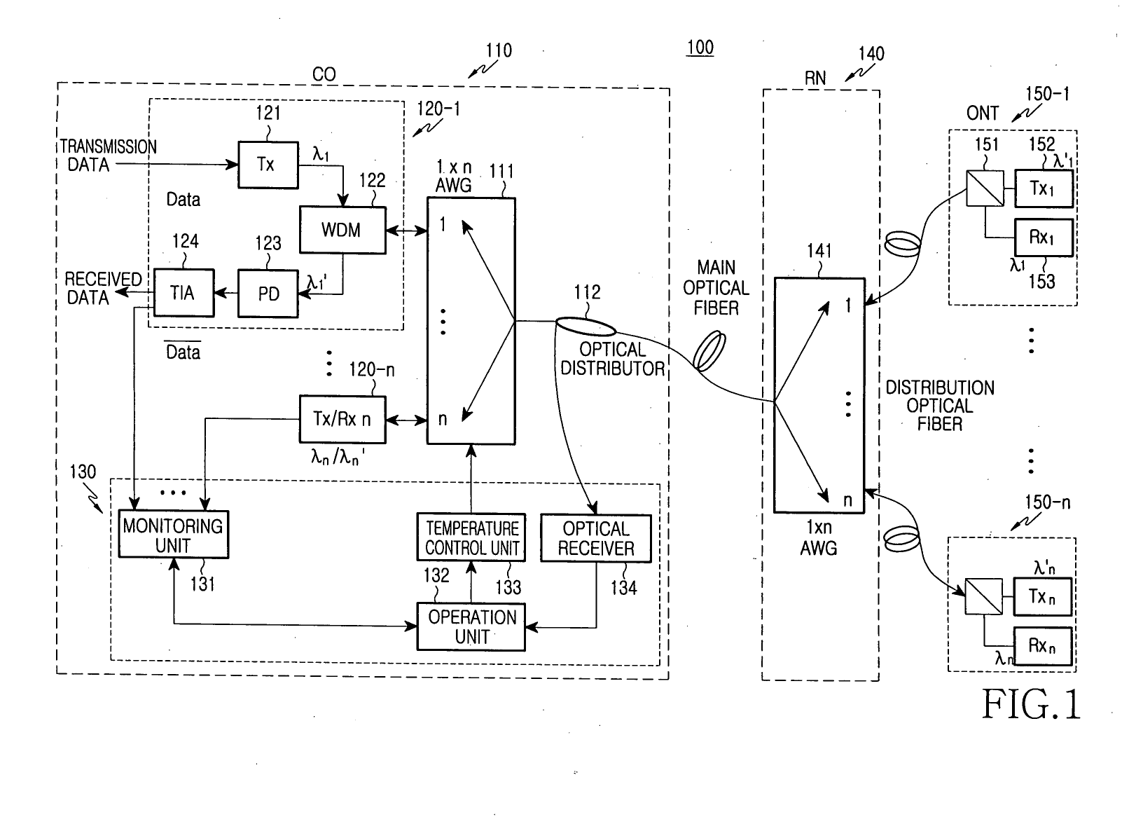

FIG. 1 is a block diagram illustrating a configuration of a wavelength division multiplexing passive optical network 100 according to a first embodiment of the present invention. The passive optical network 100 includes a plurality of optical network units 150-1 to 150-n, a central office 110 and a remote node 140. Each of the optical network units 150-1 to 150-n generates an upstream optical signal and detects a downstream optical signal of a relevant wavelength. The central office 110 generates downstream optical signals to be provided to each of the optical network units 150-1 to 150-n, differentially converts each of the upstream optical signals into a monitoring signal and a received signal, and uses the corresponding monitoring signal in order to monitor if there is an abnormality in optical lines connected to a relevant optical network unit and the change in the wavelength of each of the upstream optical signals. The remote node 140 multiplexes and outputs the upstream optical signals to the central office 110, and demultiplexes and outputs the downstream optical signals to relevant optical network units 150-1 to 150-n. The optical lines may include a main optical fiber linked between the central office 110 and the remote node 140, and a plurality of distribution optical fibers linked between the remote node 140 and each of the optical network units 150-1 to 150-n.

The central office 110 includes a plurality of transmission/reception modules 120-1 to 120-n, a first multiplexer/demultiplexer 111 for demultiplexing multiplexed upstream optical signals and multiplexing and outputting downstream optical signals, a controller 130 for monitoring if there is an abnormality in optical lines and wavelength change of the upstream optical signals and performing a corresponding control operation, and an optical distributor 112.

Each of the transmission/reception modules 120-1 to 120-n includes a downstream light source 121 for generating a downstream optical signal, an upstream optical detector 123 for detecting an upstream optical signal of a relevant wavelength, a transimpedance amplifier 124, and a wavelength division multiplexer 122. The transimpedance amplifier 124 differentially converts a detected upstream optical signal of a relevant wavelength into a received signal and a monitoring signal. The wavelength division multiplexer 122 connects the downstream light source 121 and upstream optical detector 123 to the first multiplexer/demultiplexer 111.

In one embodiment, the upstream optical detector 123 includes a photo diode that detects a current signal of an upstream optical signal having a relevant wavelength, and outputs the detected current signal to the transimpedance amplifier 124.

The transimpedance amplifier 124 differentially converts and amplifies the current signal detected by the upstream optical detector 123 into a monitoring signal and a received signal, detects data from the received signal, and outputs the monitoring signal to the controller 130.

The first multiplexer/demultiplexer 111 demultiplexes the upstream optical signals to output the upstream optical signals to relevant transmission/reception modules 120-1 to 120-n, respectively, and multiplexes the downstream optical signals generated from the transmission/reception modules 120-1 to 120-n and outputs the multiplexed downstream optical signals to the remote node 140. In one embodiment, the first multiplexer/demultiplexer 111 includes an optical arrayed waveguide grating or a wavelength division multiplexing/demultiplexing filter.

The first multiplexer/demultiplexer 111 demultiplexes and outputs multiplexed upstream optical signals through ports, in which the demultiplexed upstream optical signals are separated from each other by a predetermined wavelength interval. The first multiplexer/demultiplexer 111 shifts the entire wavelength of the demultiplexed upstream optical signals depending on changes in external temperature.

The controller 130 includes a monitoring unit 131 for monitoring wavelength change of each demultiplexed upstream optical signal by using each monitoring signal, an optical receiver 134, a temperature control unit 133 for controlling the multiplexer/demultiplexer 111, and an operation unit 132. The operation unit 132 determines wavelength changes of the optical signals and if there is an abnormality in relevant optical lines, and outputs a control signal to the temperature control unit 133 according to the result of the determination. The controller 130 monitors each optical line between the central office 110 and each of the optical network units 150-1 to 150-n and wavelength changes of the downstream and upstream optical signals, and performs a control operation depending on the results of the monitoring.

The monitoring unit 131 detects a peak voltage from each of the monitoring signals generated from the transmission/reception modules 120-1 to 120-n, and stores first-detected peak voltages in a separate memory. The monitoring unit 131 detects voltages of the monitoring signals received in realtime from the transmission/reception modules 120-1 to 120-n, and then calculates differences between the currently-detected voltages and the first-detected peak voltages.

In this way, the monitoring unit 131 stores a peak voltage of each of the monitoring signals detected in an initial operation, and compares the voltage of a realtime-detected monitoring signal with a corresponding peak voltage of the stored peak voltages. Accordingly, it is possible to monitor wavelength change in each of the upstream optical signals. When the value of a realtime-detected monitoring signal changes from the value of its corresponding peak voltage, the monitoring unit 131 calculates the degree of change in the realtime-detected monitoring signal on the basis of its corresponding peak voltage and outputs the calculated value to the operation unit 132.

The optical receiver 134 measures an intensity of multiplexed upstream optical signals distributed by the optical distributor 112, and transmits the measured intensity of the upstream optical signals to the operation unit 132.

The operation unit 132 compares voltage changes of each monitoring signal detected by the monitoring unit 131 with the intensity change of the upstream optical signals, and calculates the degree of wavelength change in each upstream optical signal. The operation unit 132 determines wavelength change of each optical signal and if there is an abnormality in a corresponding optical line, and outputs a control signal, which is used to control temperature applied to the first multiplexer/demultiplexer 111, to the temperature control unit 133.

The temperature control unit 133 changes the temperature applied to the first multiplexer/demultiplexer 111 depending on the control signal, so that the first multiplexer/demultiplexer 111 can control wavelengths of upstream optical signals to be demultiplexed according to the instruction of the temperature control unit 133.

The optical distributor 112 divides the intensity of upstream optical signals multiplexed by the remote node 140, and outputs one portion of the divided intensity to the first multiplexer/demultiplexer 111 and outputs the other portion of the divided intensity to the controller 130.

The remote node 140 is linked to the central office 110 by a main optical fiber and is linked to each of the optical network units 150-1 to 150-n by each distribution optical fiber.

The remote node 140 includes a second multiplexer/demultiplexer 141. The second multiplexer/demultiplexer 141 demultiplexes and outputs multiplexed downstream optical signals to corresponding optical network units 150-1 to 150-n, and multiplexes and outputs the upstream optical signals to the central office 110.

Each of the optical network units 150-1 to 150-n includes an upstream light source 152 for generating an upstream optical signal, a downstream optical detector 153 for detecting a downstream optical signal of a relevant wavelength, and a wavelength selection combiner 151. The wavelength selection combiner 151 links the upstream light source 152 and the downstream optical detector 153 through a corresponding distribution optical fiber to the remote node 140.

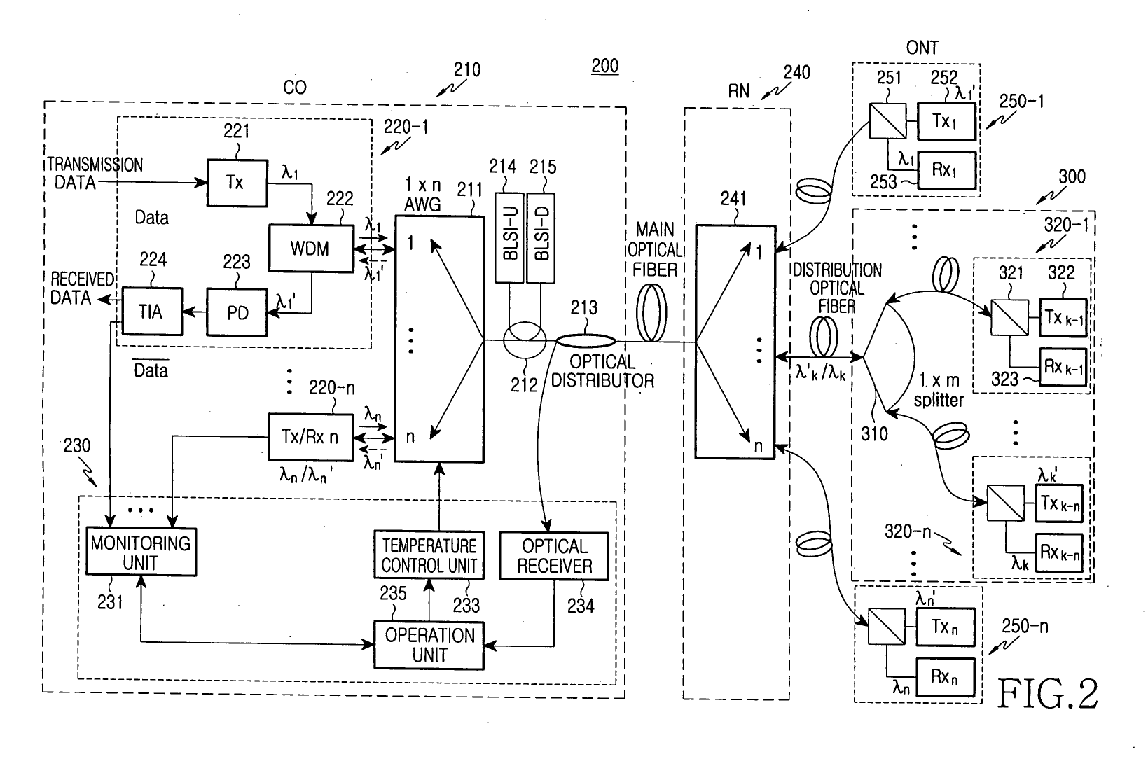

FIG. 2 is a block diagram illustrating a configuration of a wavelength division multiplexing passive optical network 200 according to a second embodiment of the present invention. The passive optical network 200 includes a plurality of optical network units 250-1 to 250-n, a central office 210, a time division relay system 300 and a remote node 240. The optical network units 250-1 to 250-n generate wavelength-locked upstream optical signals. The central office 210 generates wavelength-locked downstream optical signals. The central office 210 also differentially converts each of the upstream optical signals into a monitoring signal and a received signal, and monitors if there is an abnormality in optical lines and change in the wavelength of each of the upstream optical signals by using the monitoring signal. The time division relay system 300 generates a time-division-multiplexed upstream optical signal, and time-division demultiplexes a downstream optical signal of a relevant wavelength. The remote node 240 multiplexes and outputs the upstream optical signals to the central office 210, and demultiplexes and outputs the downstream optical signals to relevant optical network units 250-1 to 250-n and the time division relay system 300.

The central office 210 includes a plurality of transmission/reception modules 220-1 to 220-n, a first multiplexer/demultiplexer 211, a control means 230, an optical distributor 213, a downstream broadband light source 215, an upstream broadband light source 214, and an optical switch 212. The first multiplexer/demultiplexer 211 multiplexes wavelength-locked downstream optical signals, and demultiplexes multiplexed upstream optical signals. The control means 230 monitors optical lines between the central office 210 and relevant optical network units 250-1 to 250-n and also wavelength change in the downstream and upstream optical signals, and performs a control operation according to the result of the monitoring. The downstream broadband light source 215 generates a downstream light of a wide wavelength band, and the upstream broadband light source 214 generates an upstream light. The optical switch 212 connects the downstream and upstream broadband light sources 215 and 214 to the first multiplexer/demultiplexer 211 and the remote node 240.

The first multiplexer/demultiplexer 211 demultiplexes upstream optical signals multiplexed by the remote node 240 and outputs the demultiplexed upstream optical signals to corresponding transmission/reception modules 220-1 to 220-n. The first multiplexer/demultiplexer 211 also multiplexes the downstream optical signals generated by the transmission/reception modules 220-1 to 220-n and outputs the multiplexed downstream optical signals to the remote node 240. In addition, the first multiplexer/demultiplexer 211 divides the downstream light input through the optical switch 212 into downstream channels, and outputs the divided downstream lights to corresponding transmission/reception modules 220-1 to 220-n.

Each of the transmission/reception modules 220-1 to 220-n includes a downstream light source 221 for generating a wavelength-locked downstream optical signal by a downstream channel of a relevant wavelength, an upstream optical detector 223, a transimpedance amplifier 224, and a wavelength division multiplexer 222. The wavelength division multiplexer 222 connects the downstream light source 221 and the upstream optical detector 223 to the first multiplexer/demultiplexer 211.

The downstream light source 221 may include a Fabry-Perot laser, a semiconductor optical amplifier, or other device that generates a wavelength-locked downstream optical signal by a relevant downstream channel.

The upstream optical detector 223 detects an upstream optical signal of a relevant wavelength from among the upstream optical signals demultiplexed by the first multiplexer/demultiplexer 211 by converting the upstream optical signal of the relevant wavelength into current. The upstream optical detector 223 may include a photo diode and the like. The transimpedance amplifier 224 differentially amplifies currents converted from the upstream optical signal of the relevant wavelength to generate a received signal and a monitoring signal, and outputs the received signal and the monitoring signal.

Each of the transmission/reception modules 220-1 to 220-n generates a wavelength-locked downstream optical signal, and differentially converts an upstream optical signal of a relevant wavelength into a monitoring signal and a received signal, so that data can be detected from the received signal.

The optical distributor 213 divides the intensity of upstream optical signals multiplexed by the remote node 240, and outputs one portion of the divided intensity to the first multiplexer/demultiplexer 211 and outputs the other portion of the divided intensity to the control means 230.

The downstream broadband light source 215 and upstream broadband light source 214 may include a rare-earth-element-doped optical fiber amplifier or a semiconductor optical amplifier that can generate spontaneous emission light. The optical switch 212 connects the downstream and upstream broadband light sources 215 and 214 to the first multiplexer/demultiplexer 211 and the optical distributor 213.

The control means 230 includes a monitoring unit 231 for monitoring wavelength change of each upstream optical signal by using each monitoring signal, an optical receiver 234, a temperature control unit 233 for controlling temperature of the multiplexer/demultiplexer 211, and an operation unit 235. The operation unit 235 determines if each of the upstream optical signals is received and if there is an abnormality in each optical line.

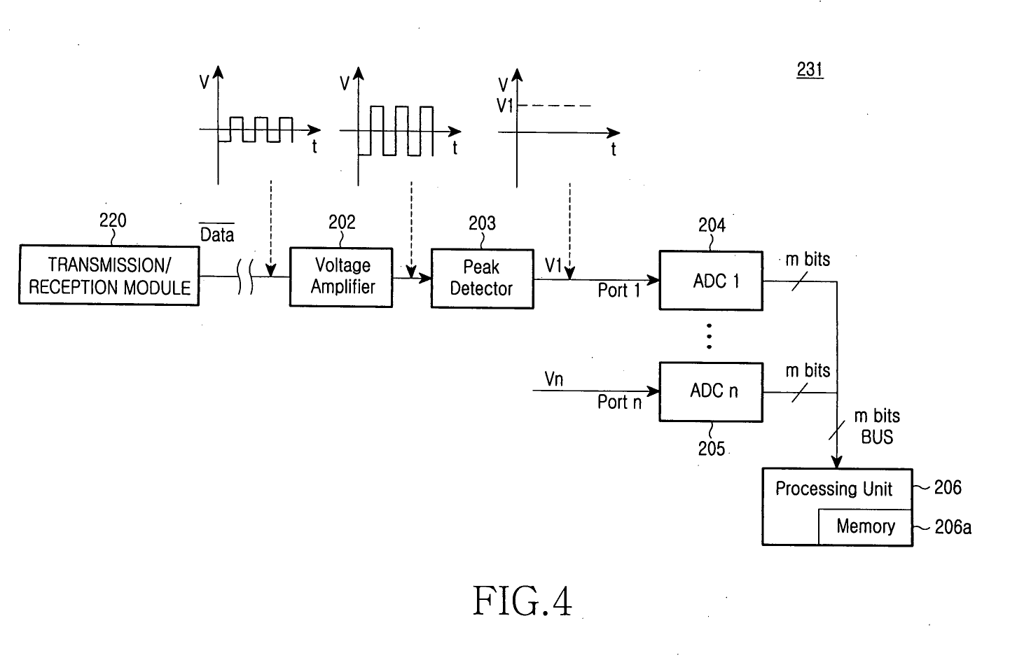

FIG. 4 is a block diagram illustrating a configuration of the monitoring unit 231 shown in FIG. 2. The monitoring unit 231 includes a voltage amplifier 202, a peak detector 203, a plurality of analog-to-digital converters 204 and 205 one-to-one corresponding to the upstream optical signals, and a processing unit 206 containing a memory 206a.

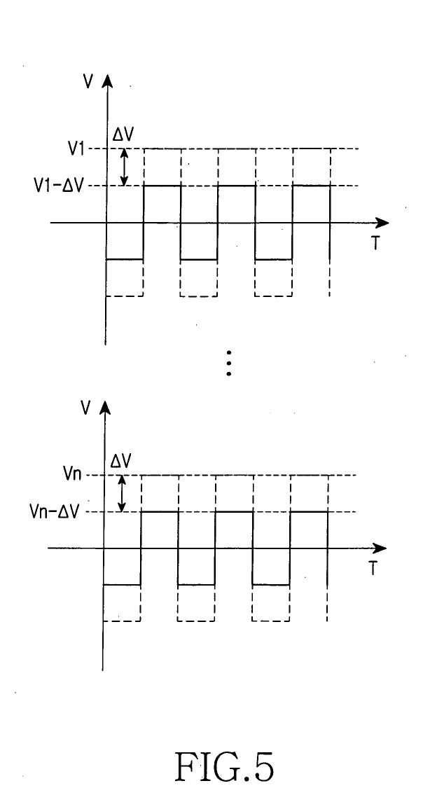

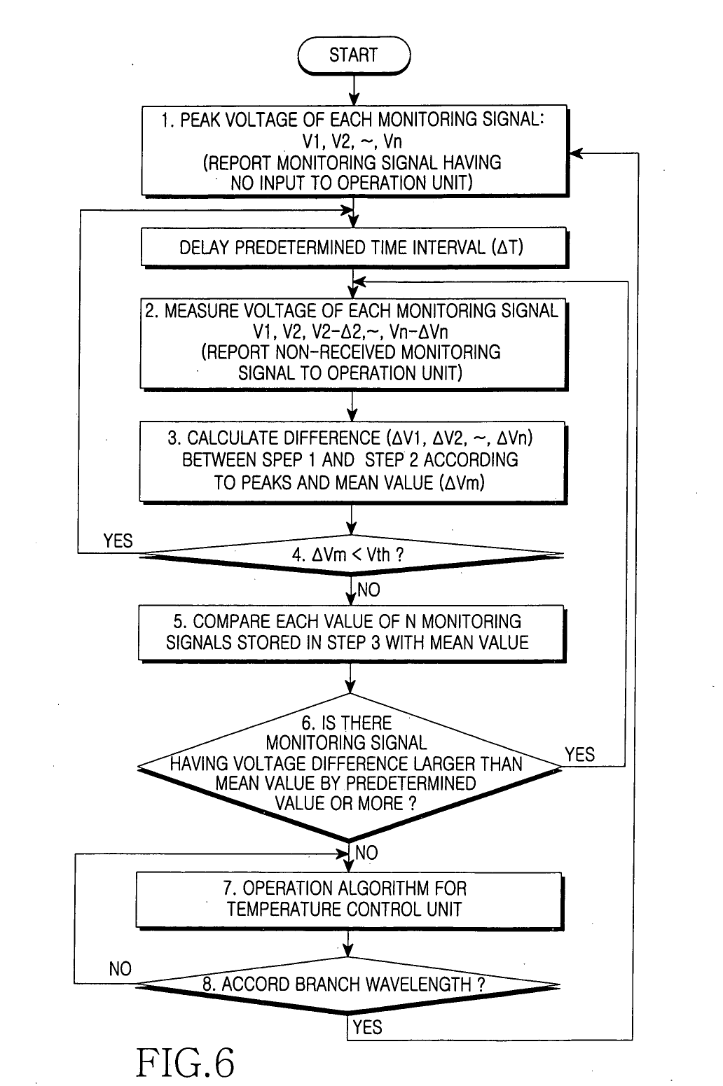

FIG. 5 is a graph for explaining a method of monitoring wavelength change of each upstream optical signal having a relevant wavelength and if there is an abnormality by using each monitoring signal. FIG. 6 is a flowchart for explaining a method of monitoring wavelength change of each demultiplexed optical signal according to an embodiment of the present invention.

The operation of the control means 230 will now be described with reference to FIGS. 5 and 6. In the monitoring unit 231, the voltage amplifier 202 amplifies the peak voltage of each monitoring signal first-received from a corresponding transimpedance amplifier 224, and the peak detector 203 detects the peak voltage of each monitoring signal which has been voltage-amplified. Each of the detected peak voltages is converted into a digital signal by a corresponding analog-to-digital converter 204 or 205, and stored in the memory 206a through the processing unit 206.

The monitoring unit 231 compares voltage changes V1-ΔV to Vn-ΔV of monitoring signals detected later with peak voltages V1 to Vn stored in the memory 206a. Accordingly, the change in the wavelength of each of the upstream optical signals is monitored. The monitoring unit 231 calculates the degree of voltage change in each upstream optical signal on the basis of a corresponding peak voltage. If there is an abnormality and change in the wavelength of each of the upstream optical signals, this is monitored.

The optical receiver 234 detects intensity of multiplexed upstream optical signals distributed by the optical distributor 213. The operation unit 235 determines there is an abnormality in the wavelength of each upstream optical signal and/or in its corresponding optical line by using the voltage change of each monitoring signal and the intensity change of the upstream optical signals. A control signal for controlling the temperature control unit 233 is generated depending on the result of the determination.

The temperature control unit 233 controls temperature of the first multiplexer/demultiplexer 211 according to the control signal, which controls the wavelengths of the upstream optical signals as needed.

The control means 230 can monitor each of the optical lines between the central office 210 and corresponding optical networks unit 250-1 to 250-n and wavelength changes of the downstream and upstream optical signals by using corresponding monitoring signals. A control operation is performed according to the result of the monitoring.

The remote node 240 includes a second multiplexer/demultiplexer 241. The second multiplexer/demultiplexer 241 demultiplexes and outputs multiplexed downstream optical signals to corresponding optical network units 250-1 to 250-n and the time division relay system 300, and multiplexes and outputs the upstream optical signals to the central office 210. In addition, the second multiplexer/demultiplexer 241 divides the upstream light input through the optical distributor 213 and the like into upstream channels, and outputs the divided upstream lights to corresponding optical network units 250-1 to 250-n and the time division relay system 300.

Each of the optical network units 250-1 to 250-n includes an upstream light source 252 for generating an upstream optical signal wavelength-locked by an upstream channel of a corresponding wavelength, a downstream optical detector 253 for detecting a downstream optical signal of a relevant wavelength from among demultiplexes downstream optical signals, and a wavelength selection combiner 251 for linking the upstream light source 252 and the downstream optical detector 253 to the remote node 240.

The time division relay system 300 includes a plurality of time division subscriber units 320-1 to 320-n and a time splitter 310. The time splitter 310 time-division demultiplexes a downstream optical signal of a relevant wavelength to a plurality of downstream time slots, and outputs the demultiplexed downstream time slots to corresponding time division subscriber units 320-1 to 320-n. The time splitter 310 also time-division multiplexes upstream time slots generated by the time division subscriber units 320-1 to 320-n to an upstream optical signal, and outputs the multiplexed upstream optical signal to the remote node 240. The time splitter 310 may include a power splitter.

Each of the time division subscriber units 320-1 to 320-n includes a time slot detector 323 for detecting a corresponding downstream time slot from among a plurality of time-division-demultiplexed downstream time slots, a time slot generator 322 for generating an upstream time slot, and a time connector 321 for connecting the time slot detector 323 and the time slot generator 322 to the time splitter 310.

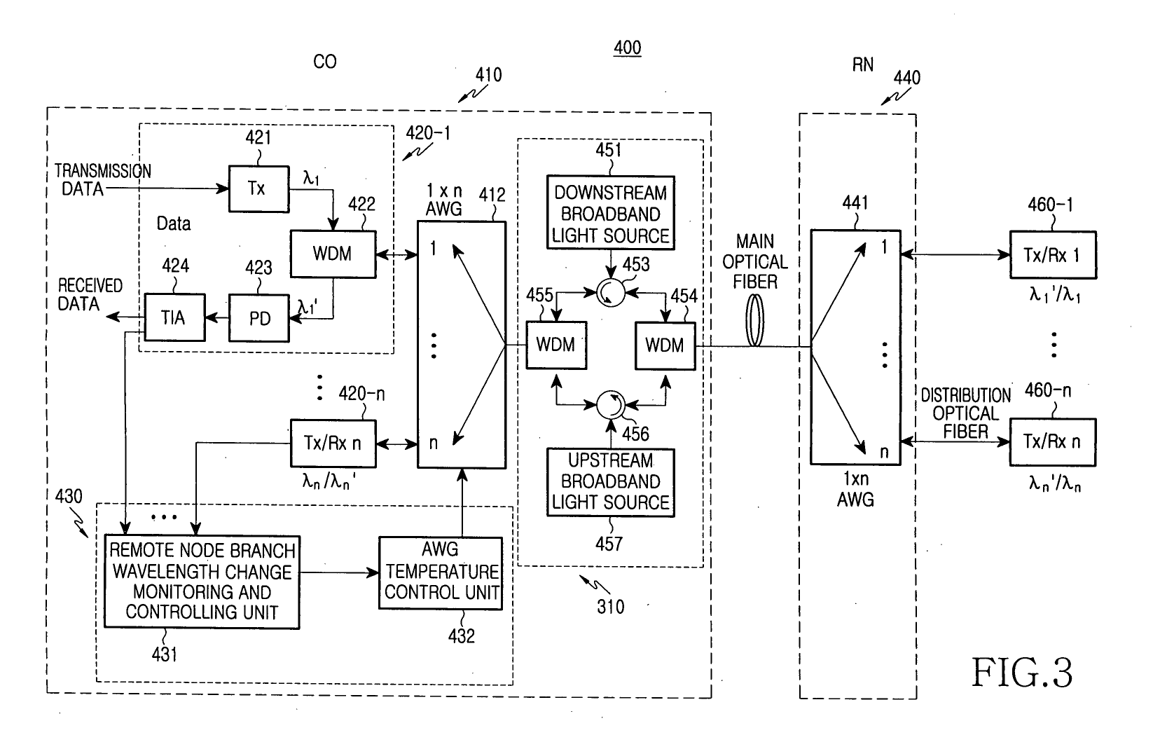

FIG. 3 is a block diagram illustrating a configuration of a wavelength division multiplexing passive optical network 400 according to a third embodiment of the present invention. The passive optical network 400 includes a plurality of optical network units 460-1 to 460-n, a central office 410, and a remote node 440. Each of the optical network units 460-1 to 460-n generates a wavelength-locked upstream optical signal, and the central office 410 generates wavelength-locked downstream optical signals. The remote node 440 is located between the central office 410 and the optical network units 460-1 to 460-n.

The central office 410 includes a plurality of transmission/reception modules 420-1 to 420-n, a first multiplexer/demultiplexer 412, a control means 430, and a circulation unit 310. Each of the transmission/reception modules 420-1 to 420-n generates a downstream optical signal, and differentially converts an upstream optical signal of a relevant wavelength into a monitoring signal and a received signal, thereby detecting the received signal. The first multiplexer/demultiplexer 412 divides downstream light into a plurality of incoherent channels having different wavelengths and outputs the divided incoherent channels to corresponding transmission/reception modules 420-1 to 420-n, and multiplexes and outputs wavelength-locked downstream optical signals generated from the transmission/reception modules 420-1 to 420-n. The control means 430 monitors each of optical lines between the central office 410 and the optical network units 460-1 to 460-n and wavelength change of the downstream and upstream optical signals by using a monitoring signals. A control operation is performed according to the result of the monitoring.

Each of the transmission/reception modules 420-1 to 420-n includes a downstream light source 421 for generating a downstream optical signal, an upstream optical detector 423 for detecting an upstream optical signal of a relevant wavelength, a transimpedance amplifier 424, and a wavelength division multiplexer 422. The transimpedance amplifier 424 differentially converts a detected upstream optical signal of a relevant wavelength into a received signal and a monitoring signal. The wavelength division multiplexer 422 connects the downstream light source 421 and upstream optical detector 423 to the first multiplexer/demultiplexer 412.

The control means 430 includes a monitoring unit 431 and a temperature control unit 432. The monitoring unit 431 detects voltage changes in each monitoring signal on the basis of the peak voltages first-received from corresponding transmission/reception modules 420-1 to 420-n, and generates a control signal according to the detected voltage change. The temperature control unit 432 controls temperature of the first multiplexer/demultiplexer 412 according to the control signal.

The circulation unit 310 includes a downstream broadband light source 451 for generating the downstream light, an upstream broadband light source 457 for generating the upstream light, a first wavelength coupler 455, a second wavelength coupler 454, a first circulator 453, and a second circulator 457.

The downstream broadband light source 451 and the upstream broadband light source 457 may include a rare-earth-element-doped optical fiber amplifier or a semiconductor optical amplifier that can generate different wavelengths.

The first wavelength coupler 455 outputs the downstream light and multiplexed upstream optical signals to the first multiplexer/demultiplexer 412, and outputs the multiplexed downstream optical signals to the remote node 440 through the second wavelength coupler 454. The second wavelength coupler 454 outputs the upstream light and multiplexed downstream optical signals to the remote node 440, and outputs the multiplexed upstream optical signals to the first multiplexer/demultiplexer 412 through the first wavelength coupler 455.

The first circulator 453 outputs the downstream light generated by the downstream broadband light source 451 to the first wavelength coupler 455, and outputs the downstream optical signals output from the first wavelength coupler 455 to the second wavelength coupler 454. The second circulator 457 outputs the upstream light generated by the upstream broadband light source 457 to the remote node 440 through the second wavelength coupler 454, and outputs the upstream optical signals output from the second wavelength coupler 454 to the first wavelength coupler 455.

The circulation unit 310 generates downstream and upstream lights of wide wavelength bands and wavelength-locked downstream optical signals, outputs the downstream optical signals to the remote node 440, and outputs the upstream optical signals input from the remote node 440 to the first multiplexer/demultiplexer 412.

The remote node 440 includes a second multiplexer/demultiplexer 441. The multiplexer/demultiplexer 441 multiplexes upstream optical signals input from the optical network units 460-1 to 460-n and outputs the multiplexed upstream optical signals to the central office 410, and demultiplexes and outputs the downstream optical signals multiplexed by the central office 410 to corresponding optical network units 460-1 to 460-n. In addition, the multiplexer/demultiplexer 441 divides the upstream light into incoherent channels having different wavelengths and outputs the divided incoherent channels to corresponding optical network units 460-1 to 460-n. The multiplexer/demultiplexer 441 may include an optical arrayed waveguide grating or a wavelength division multiplexing/demultiplexing filter.

Each of the optical network units 460-1 to 460-n detects a corresponding downstream optical signal, and generates an upstream optical signal wavelength-locked by a relevant incoherent channel.

As described above, according to the embodiments of the present invention, the passive optical network includes a controller for monitoring optical lines and changes in wavelengths for each optical signal. This allows for the cause of an error and the cause of non-reception of an optical signal to be identified.

While the present invention has been shown and described with reference to certain embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A wavelength division multiplexing passive optical network including optical lines for link, the passive optical network comprising:
a plurality of optical network units each of which generates an upstream optical signal;
a central office for generating downstream optical signals to be provided to each of the optical network units, and differentially converting each of the upstream optical signals into a monitoring signal and a received signal, wherein the monitoring signal is used to detect changes in the wavelength of each of the upstream optical signals; and
a remote node for multiplexing and outputting the upstream optical signals to the central office, and demultiplexing and outputting the downstream optical signals to corresponding optical network units.

2. The passive optical network as claimed in claim 1, wherein the central office comprises:
a plurality of transmission/reception modules for generating each downstream optical signal, and differentially converting an upstream optical signal of a relevant wavelength into the monitoring signal and the received signal;
a first multiplexer/demultiplexer for demultiplexing and outputting the upstream optical signals to corresponding transmission/reception modules, and multiplexing and outputting the downstream optical signals generated by the transmission/reception modules to the remote node;
a control unit for monitoring optical lines between the central office and corresponding optical network units and wavelength changes of the downstream and upstream optical signals by using the relevant monitoring signals, and performing a control operation according to the result of the monitoring; and
an optical distributor for dividing intensity of upstream optical signals multiplexed by the remote node, and outputs one portion of the divided intensity to the first multiplexer/demultiplexer and outputs a remaining portion of the divided intensity to the control means.

3. The passive optical network as claimed in claim 2, wherein each of the transmission/reception modules comprises:
a downstream light source for generating a downstream optical signal;
an upstream optical detector for detecting an upstream optical signal of a relevant wavelength;
a transimpedance amplifier for differentially converting the detected upstream optical signal of the relevant wavelength into the received signal and the monitoring signal; and
a wavelength division multiplexer for connecting the downstream light source and the upstream optical detector to the first multiplexer/demultiplexer.

4. The passive optical network as claimed in claim 2, wherein the control unit comprises:
a monitoring unit for detecting voltage change of each monitoring signal on the basis of a peak voltages of the monitoring signals first-received from corresponding transmission/reception modules;
an optical receiver for sensing change in intensity of the multiplexed upstream optical signals divided by the optical distributor;
a temperature control unit for controlling temperature of the multiplexer/demultiplexer; and
an operation unit for comparing voltage changes of each monitoring signal detected by the monitoring unit with the intensity change of the multiplexed upstream optical signals, and calculating a degree of wavelength change in each upstream optical signal, and outputting a control signal for controlling temperature of the first multiplexer/demultiplexer to the temperature control unit.

5. A wavelength division multiplexing passive optical network including optical lines for link, the passive optical network comprising:
a plurality of optical network units for generating respective wavelength-locked upstream optical signals;
a central office for generating wavelength-locked downstream optical signals, and differentially converting each of the upstream optical signals into a monitoring signal and a received signal, wherein the monitoring signal is used to detect changes in the wavelength of each of the upstream optical signals;
a time-division relay system for generating a time-division-multiplexed upstream optical signal, and time-division demultiplexing a downstream optical signal of a relevant wavelength; and
a remote node for multiplexing and outputting the upstream optical signals to the central office, and demultiplexing and outputting the downstream optical signals to corresponding optical network units and the time-division relay system.

6. The passive optical network as claimed in claim 5, wherein the central office comprises:
a plurality of transmission/reception modules for generating downstream optical signals, and differentially converting an upstream optical signal of a relevant wavelength into the monitoring signal and the received signal;
a first multiplexer/demultiplexer for demultiplexing and outputting the upstream optical signals to corresponding transmission/reception modules, and multiplexing and outputting the downstream optical signals to the remote node;
a control unit for monitoring optical lines between the central office and corresponding optical network units and wavelength changes of the downstream and upstream optical signals by using relevant monitoring signals, and performing a control operation according to the result of the monitoring; and
an optical distributor for dividing intensity of upstream optical signals multiplexed by the remote node, and outputs one portion of the divided intensity to the first multiplexer/demultiplexer and outputs a remaining portion of the divided intensity to the control means.

7. The passive optical network as claimed in claim 6, wherein the central office further comprises:
a downstream broadband light source for generating downstream light of a wide wavelength band for wavelength-locking each of the transmission/reception modules;
an upstream broadband light source for generating upstream light for wavelength-locking each of the optical network units; and
an optical switch for connecting the downstream and upstream broadband light sources to the first multiplexer/demultiplexer and the remote node.

8. The passive optical network as claimed in claim 6, wherein each of the transmission/reception modules comprises:
a downstream light source for generating a downstream optical signal;
an upstream optical detector for detecting an upstream optical signal of a relevant wavelength;
a transimpedance amplifier for differentially converting the detected upstream optical signal of the relevant wavelength into a received signal and a monitoring signal; and
a wavelength division multiplexer for connecting the downstream light source and the upstream optical detector to the first multiplexer/demultiplexer.

9. The passive optical network as claimed in claim 6, wherein the control unit comprises:
a monitoring unit for comparing a voltage of a relevant monitoring signal with a peak voltage of the monitoring signal first-received from a corresponding transmission/reception module;
an optical receiver for detecting intensity of the multiplexed upstream optical signals divided by the optical distributor;
a temperature control unit for controlling the multiplexer/demultiplexer; and
an operation unit for determining if there is an abnormality in wavelength of each upstream optical signal by using voltage change of each monitoring signal and intensity change of the upstream optical signals, and generating a control signal for controlling the temperature control unit based on the determination.

10. The passive optical network as claimed in claim 5, wherein the time division relay system comprises:
a time splitter for time-division demultiplexing a downstream optical signal of a relevant wavelength to a plurality of downstream time slots and outputting the demultiplexed downstream time slots, and time-division multiplexing a plurality of upstream time slots to an upstream optical signal, and outputs the multiplexed upstream optical signal to the remote node; and
a plurality of time division subscriber units for detecting a corresponding downstream time slot from among the downstream time slots, and generating each of the upstream time slots.

11. The passive optical network as claimed in claim 10, wherein each of the time division subscriber units comprises:
a time slot detector for detecting a corresponding downstream time slot from among a plurality of time-division-demultiplexed downstream time slots;
a time slot generator for generating the upstream time slot; and
a connector for connecting the time slot detector and the time slot generator to the time splitter.

12. The passive optical network as claimed in claim 10, wherein the time splitter includes a power splitter.

13. A wavelength division multiplexing passive optical network including optical lines for link, the passive optical network comprising:
a plurality of optical network units for generating each of wavelength-locked upstream optical signals;
a central office for generating downstream and upstream lights of a wide wavelength band and wavelength-locked downstream optical signals, differentially converting each of the upstream optical signals into a monitoring signal and a received signal so that changes in the wavelength of each of the upstream optical signals and and abnormalities in a relevant optical line are monitored by using the monitoring signal, and including a circulation unit for generating downstream and upstream lights and inputting/outputting the downstream and upstream optical signals; and
a remote node for multiplexing and outputting the upstream optical signals to the central office, and demultiplexing and outputting the downstream optical signals to corresponding optical network units.

14. The passive optical network as claimed in claim 13, wherein the central office comprises:
a plurality of transmission/reception modules for generating a downstream optical signal, and differentially converting an upstream optical signal of a relevant wavelength into a monitoring signal and a received signal so as to detect the received signal;
a first multiplexer/demultiplexer for dividing the downstream light into a plurality of incoherent channels having different wavelengths and outputting the divided incoherent channels to corresponding transmission/reception modules, and multiplexing and outputting downstream optical signals wavelength-locked by the transmission/reception modules; and
a control means for monitoring optical lines between the central office and corresponding optical network units and wavelength changes of the downstream and upstream optical signals by using relevant monitoring signals, and performing a control operation according to the result of the monitoring.

15. The passive optical network as claimed in claim 13, wherein the circulation unit comprises:
a downstream broadband light source for generating the downstream light;
an upstream broadband light source for generating the upstream light;
a first wavelength coupler for outputting the downstream light and multiplexed upstream optical signals to the first multiplexer/demultiplexer, and outputting the multiplexed downstream optical signals to the remote node;
a second wavelength coupler for outputting the upstream light and multiplexed downstream optical signals to the remote node, and outputting the multiplexed upstream optical signals to the first multiplexer/demultiplexer;
a first circulator for outputting the downstream light generated by the downstream broadband light source to the first wavelength coupler, and outputting the downstream optical signals output from the first wavelength coupler to the second wavelength coupler; and
a second circulator for outputting the upstream light generated by the upstream broadband light source to the remote node, and outputting the upstream optical signals output from the second wavelength coupler to the first wavelength coupler.

16. The passive optical network as claimed in claim 14, wherein each of the transmission/reception modules comprises:
a downstream light source for generating a downstream optical signal;
an upstream optical detector for detecting an upstream optical signal of a relevant wavelength;
a transimpedance amplifier for differentially converting the detected upstream optical signal of the relevant wavelength into a received signal and a monitoring signal; and
a wavelength division multiplexer for connecting the downstream light source and the upstream optical detector to the first multiplexer/demultiplexer.

17. The passive optical network as claimed in claim 14, wherein the control unit comprises:
a monitoring unit for detecting voltage change of a relevant monitoring signal based on a peak voltage of a monitoring signal first-received from a corresponding transmission/reception module, and generating a control signal according to the result of the detection; and
a temperature control unit for controlling temperature of the multiplexer/demultiplexer according to the control signal.

18. The passive optical network as claimed in claim 13, wherein the remote node comprises a second multiplexer/demultiplexer.
